(19) United States
(12) Patent Application Publication
(10) Pub. No.: US 2015/0096279 A1
(43) Pub. Date: Apr. 9, 2015

(54) REEL FINGER WITH ALIGNMENT PIN

(71) Applicant: Deere & Company, Moline, IL (US)

(72) Inventors: BRIAN HERRINGSHAW, BETTENDORF, IA (US); JESSE R. NEELY, ANNAWAN, IL (US); TERRY L. DEMAY, ANNAWAN, IL (US); JOSHUA PIERSON, DAVENPORT, IA (US)

(21) Appl. No.: 14/046,303

(22) Filed: Oct. 4, 2013

(51) Int. Cl. A01D 57/02; A01D 80/02

(52) U.S. Cl. CPC A01D 57/02; A01D 80/02
USPC 56/220; 264/271.1; 56/400

(57) ABSTRACT

A finger (100) for a bat (116) of a reel of an agricultural harvesting head, wherein the finger (100) includes an alignment pin (122) that is configured to be received in a mating aperture (124) of the bat (116), the finger comprising an upper clamp portion (104) with an alignment pin (122), and wherein the alignment pin (122) comprises a material having greater wear resistance or greater tensile strength than the upper clamp portion (104).

### FIELD OF THE INVENTION

This invention relates to harvesting heads for agricultural harvesters. In particular, it relates to reels for harvesting heads. More particularly, it relates to crop-engaging fingers mounted on bats of the reels.

### BACKGROUND OF THE INVENTION

Harvesting heads for agricultural harvesters typically have reels that engage the top parts of the crop plants and sweep them backwards on to the harvesting head itself. This ensures that the crop plants, when the roots are severed by reciprocating knife at the base of the plant, fall onto the harvesting head itself, instead of falling on the ground and being wasted.

The reels are typically constructed as several long bats that have fingers that extend downward from the bat and engage the tops of the crop plants. The bats are typically formed as elongate aluminum alloy tubes between 2 and 4 cm in diameter. The fingers include an upper end that is clamped to the outer surface of the tube and a lower end in the form of an elongate finger that is formed integral with the upper end. As the bat rotates, it rotates all of the fingers causing the lower ends of the fingers to gently engage the upper portion of the crop and to pull it backwards.

The fingers are prevented from rotating around the bat by alignment structures that mechanically engage the finger in the bat such that the finger cannot rotate about the bat without the alignment structures being sheared. The alignment structure is typically a plastic or metal pin or protrusion, a screw or a bolt.

In one arrangement, the finger is injection molded out of plastic. In this case, the alignment structure is typically a plastic protrusion, stud, or surface irregularity that is injection molded integral with the finger and of the same material and that mechanically engages the bat.

When these plastic alignment structures are placed under load, they tend to wear against the aluminum alloy of the bat, and eventually the plastic alignment structure either shears off or is worn away. When this happens, the fingers are free to rotate about the bat and no longer engage the tops of the crop plants properly.

What is needed therefore is a finger with stronger alignment members that are less subject to wear or shearing. It is an object of this invention to provide such a finger.

### SUMMARY OF THE INVENTION

In accordance with a first aspect of the invention, a finger configured to be mounted on a bat of a reel of an agricultural harvesting head is provided, the bat defining a mating aperture configured to receive a portion of the finger, the finger comprising: an elongate lower finger portion configured to engage upper portions of crop plants; an upper clamp portion integrally formed with the elongate lower finger portion, wherein the upper clamp portion defines a central region configured to receive the bat, the upper clamp portion further comprising, a strap comprising a polymer that is configured to wrap around the bat and to be attached to the bat, and an alignment pin disposed on an inner surface of the strap and extending into the central region wherein the alignment pin is configured to be received within a mating aperture in the bat, and wherein an outer surface of the alignment pin comprises a material having greater wear resistance and/or greater tensile strength than the upper clamp portion.

The finger may be solid, may be comprised of ferrous alloy, may be comprised of plastic, may be comprised of reinforced plastic, and may be comprised of brass or bronze

The upper clamp portion may define an aperture that is configured to receive and support an end of the alignment pin.

The elongate lower finger portion and the upper clamp portion may be formed as a single injection molded plastic part, and the alignment pin may be pressed into an aperture in the upper clamp portion.

The elongate lower finger portion and the upper clamp portion are formed as a single injection molded plastic part, in which they are molded around the alignment pin.

The finger may further comprise a threaded fastener that extends through a first aperture in a free end of the strap and is threadedly received in a second aperture formed in a receiver of the upper clamp portion.

The threaded fastener may not extend into the bat.

The alignment pin may be generally circular in cross-section, and the mating aperture may be generally circular in cross-section.

A coating, layer, or skin may be provided on an outer surface of the alignment pin that is disposed between the alignment pin and the mating aperture.

In accordance with another aspect of the invention, a method of molding a finger configured to be mounted on a bat of a reel of an agricultural harvesting head is provided, the bat defining a mating aperture configured to receive a portion of the finger, wherein the method of molding a finger comprises the steps of: molding as a unitary body an upper clamp portion configured to fix the finger to the bat and an elongate finger portion configured to engage upper portions of crop plants; and simultaneously molding an aperture in the upper clamp portion that is configured to support an alignment pin, wherein the alignment pin is configured to be received in the mating aperture.

The step of simultaneously molding an aperture may further comprise the step of mold-forming the aperture about the alignment pin.

The method may further comprise a step of simultaneously molding a coating, layer, or skin over an outer surface of the alignment pin.

### BRIEF DESCRIPTION OF THE DRAWINGS

FIG. 1 is a side view of reel finger in accordance with the present invention.

FIG. 2 is a front view of the reel finger of FIG. 1.

FIG. 3 is a fragmentary side view of the upper portion of the reel finger of FIGS. 1-2.

FIG. 4 is a fragmentary perspective left side view of the upper portion of the reel finger of FIGS. 1-3.

FIG. 5 is a fragmentary perspective right side view of the upper portion of the reel finger of FIGS. 1-4.

FIG. 6 is a longitudinal cross-sectional view of the reel finger of FIGS. 1-5 taken at section line 6-6 in FIG. 2.

FIG. 7 is a longitudinal cross-sectional view of an alternative reel finger arrangement in which the ring and alignment pin have been replaced with an alignment pin that extends into an elongate aperture formed in the upper portion of the reel finger.

FIG. 8 shows cross-sections of the alternative reel finger arrangement of FIG. 7 that are taken along section line 8-8 in FIG. 7.

### DETAILED DESCRIPTION OF THE PREFERRED EMBODIMENTS

Referring to the Figures herein, a reel finger 100 comprises an elongate lower finger portion 102 and an upper clamp portion 104. The lower finger portion 102 and the upper clamp portion 104 are integrally formed, preferably as a single injection molded polymeric part.

The reel finger 100 may be formed of nylon, polypropylene, high molecular weight polyethylene, and ultra-high molecular weight polyethylene. The reel finger may be reinforced, such as by glass fibers, carbon fibers, glass beads or other like materials used to strengthen or improve the wear resistance of thermoplastics.

The upper clamp portion 104 comprises a strap 106 and a collar 108. The collar 108 is disposed at a distal end of the strap 106 and defines an aperture 110 configured to receive a threaded fastener 112 such as a bolt or screw. The upper clamp portion 104 also comprises a receiver 114 which is provided with an aperture 115 to receive and threadedly engage the threaded shank of the threaded fastener 112.

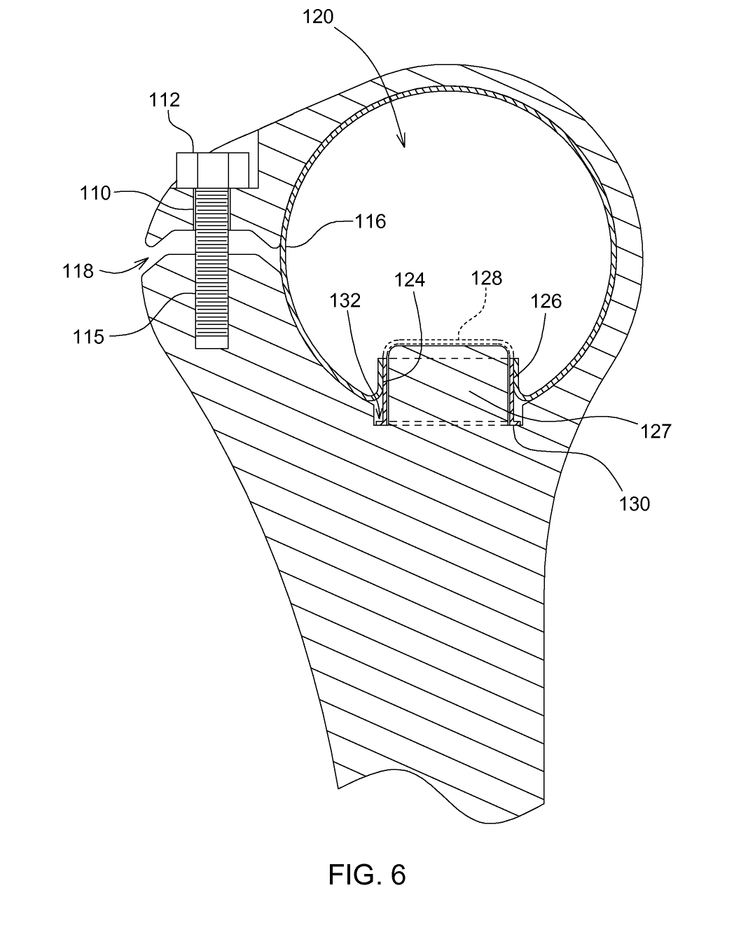

To mount the reel finger 100 on a bat 116 (FIG. 6) the collar 108 and the strap 106 are flexed outward away from the receiver 114 to enlarge the gap 118 that is located between the collar 108 and the receiver 114. When the gap 118 has been increased to the diameter of the bat 116 (which is roughly equal to the as-molded diameter “D” formed by the strap 106), the bat 116 is forced into a generally circular central region 120 formed by the as-molded shape of the strap 106.

The strap 106 is then flexed back to its original shape (substantially as shown in all of Figures herein) in which the generally circular central region 120 is circular, and the threaded fastener 112 is inserted into the aperture 110 in the collar 108. The free end of the threaded fastener 112 is inserted until it engages the aperture 115, at which time the threaded fastener 112 is threaded into the aperture 115 which encloses the bat 116 and clamps the upper clamp portion 104 on to the bat 116. The threaded fastener 112 in the illustrated arrangement does not extend into the bat 116. Instead, it pulls the two free ends of the strap 106 together, thereby increasing the tension in the strap 106 and therefore the pressure of the strap 106 against the bat 116. The threaded fastener 112 does not extend into the bat 116 and therefore does not function to align the reel finger 100 with respect to the bat 116.

The friction between the inner surface of the strap 106 and the outer surface of the bat 116 may not be sufficient to keep the reel finger 100 from rotating on the bat 116 when the lower finger portion 102 engages the tops of crop plants during harvesting.

For this reason, the upper clamp portion 104 further comprises an alignment pin 122 that extends inwardly from an inner surface of the strap 106 into the generally circular central region 120 and generally toward the center of the generally circular central region 120. The bat 116 (FIG. 6) is generally circular in cross-section, and is provided with a mating aperture 124 that is configured to receive the alignment pin 122. The alignment pin 122 may be circular in cross-section.

The alignment pin 122 further comprises a ring 126 that is disposed about a central portion 127 of the alignment pin 122 to provide a more wear resistant and stronger outer surface for the alignment pin 122.

The central portion 127 of the alignment pin is preferably molded out of the same material (and in the same process) as the elongate lower finger portion 102 and the upper clamp portion 104. It is the outer surface of the ring 126 that abuts the interior surface of the mating aperture 124.

The ring 126 comprises a more wear resistant and stronger material than the material that forms the upper clamp portion 104 and that forms the central portion 127. This material may be a plastic or a metal.

In one arrangement the ring 126 comprises a ferrous alloy. In another arrangement it comprises a brass alloy. In another arrangement the ring 126 is comprised of a bronze alloy. In another arrangement, the ring 126 comprises a reinforced plastic. In another arrangement, the ring 126 comprises a glass or fiber filled plastic. The ring 126 may have an integrally formed cover portion 128 disposed at its upper end such that it forms a cap. The ring 126 may have a flange 130 disposed at its lower end to provide greater strength and easier assembly. The ring 126 may be right circular cylinder in cross-section.

In one arrangement, the ring 126 may be inserted into a mold cavity, the mold cavity closed, and the plastic that forms the reel finger 100 can be then be injected into the mold cavity to form the finger integrally with the ring 126. In another arrangement, the reel finger 100 can be molded and the ring 126 later pressed onto the (now solid) alignment pin 122.

The upper clamp portion 104 is provided with a recess 132 that extend circumferentially around the base of the alignment pin 122 and is configured to receive the lower end of the ring 126.

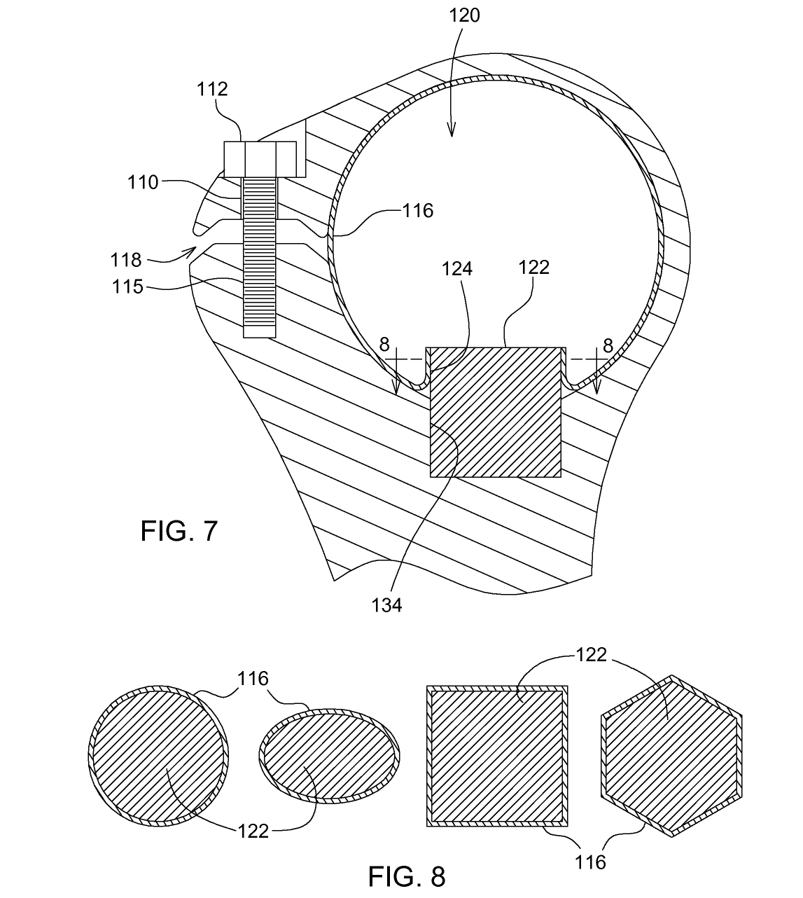

Referring now to FIGS. 7-8, an alternative arrangement of the reel finger 100 is shown.

In one method of forming the arrangement of FIGS. 7-8, a unitary reel finger 100 with an upper clamp portion 104 and a lower finger portion 102 is first molded in an injection molding machine. The molds for this injection molding machine also mold the inner surfaces of the aperture 134. The alignment pin 122 is then inserted into the aperture 134. The reel finger 100 of FIG. 7-8 is then attached to the bat 116 as described above.

In another method of forming the arrangement of FIGS. 7-8 the alignment pin 122 is placed in a mold cavity, and then the reel finger 100 is molded around the alignment pin, and the alignment pin 122 defines the inner surface of the aperture 134 by having plastic resin molded around it. This method has the advantage of providing a closer bond between the alignment pin 122 in the aperture 134. It does, however, require inserting the alignment pin 122 into the mold cavity that forms the reel finger 100 prior to the injection molding process.

The alignment pin 122 in the arrangement of FIG. 7-8 is formed of a material that is different than the molded portions of the upper clamp portion 104. The material of the alignment pin 122 is chosen to have a wear resistance and/or a greater tensile strength than the material that comprises the rest of the upper clamp portion 104.

In FIG. 8, the profiles of several alternative alignment pins 122 are shown. The alignment pin 122 can be round, oval, square, or polygonal as illustrated. The corresponding apertures 134 in which the alignment pin 122 is received can have profiles that match the profiles of the alignment pin 122 thereby providing for a close fit between the alignment pin 122 and the aperture 134.

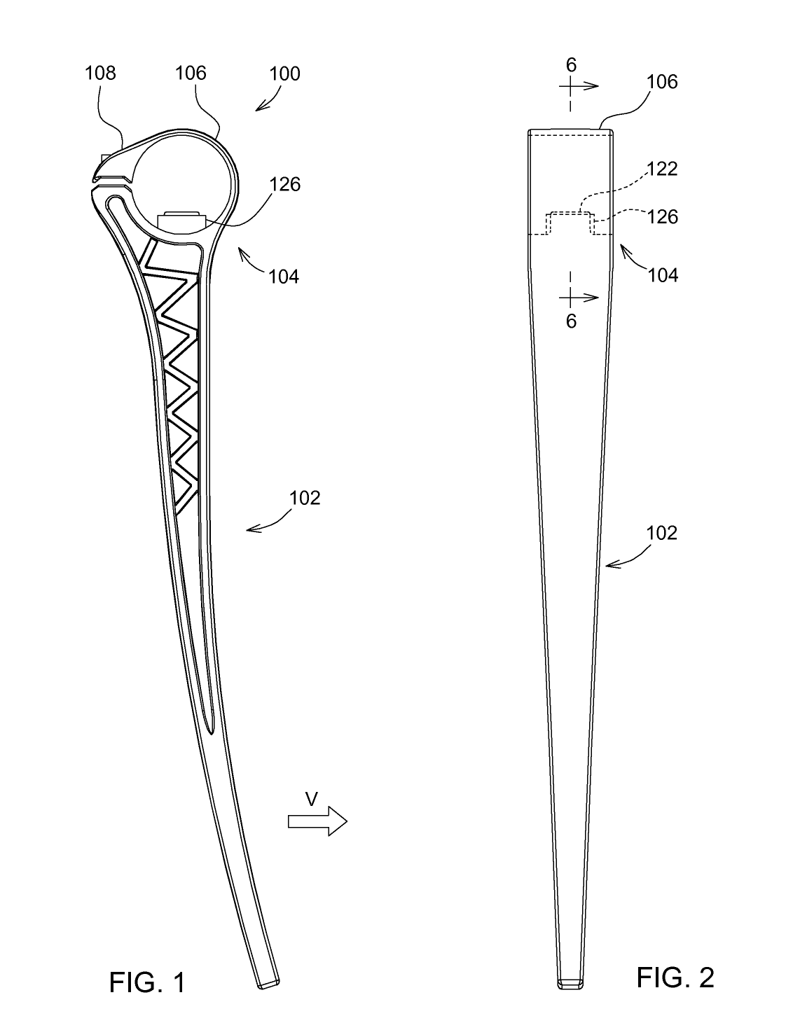

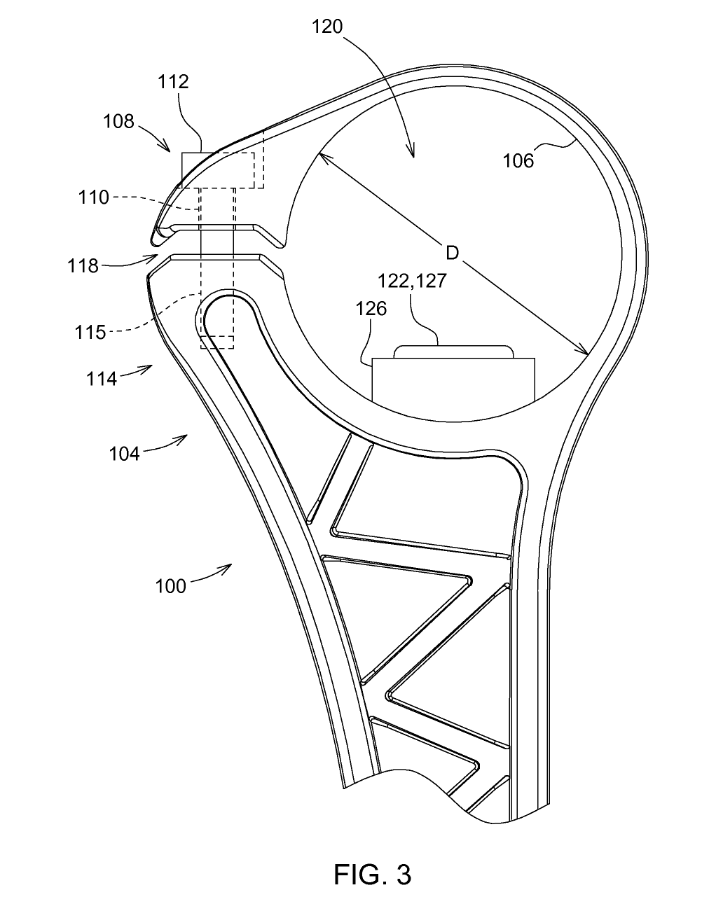

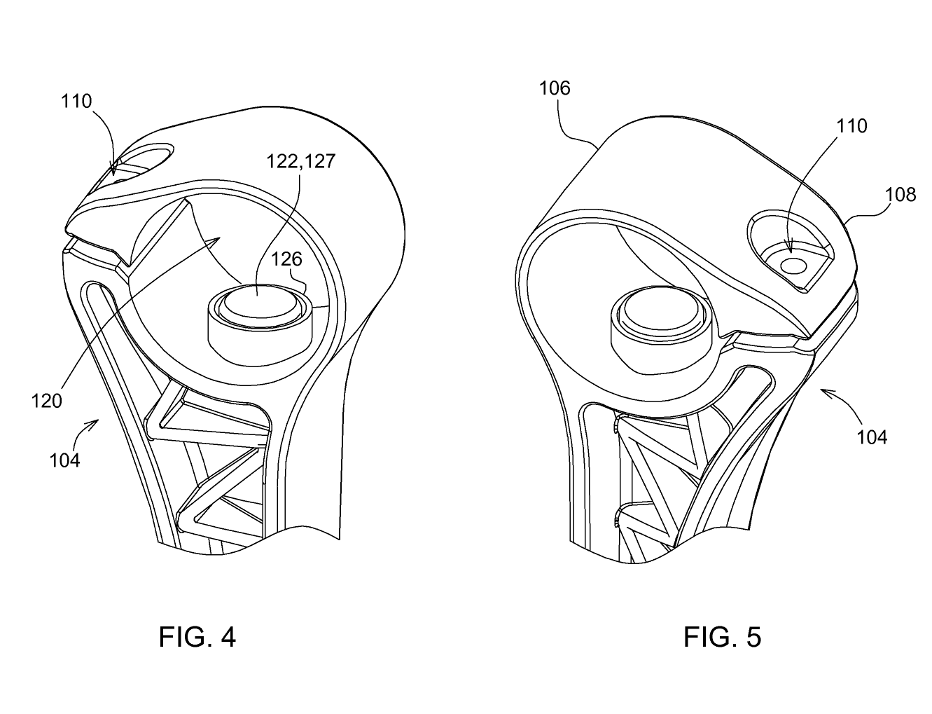

Both the arrangement of FIGS. 1-6 and the arrangement of FIGS. 7-8 share at least one common characteristic: they both provide an alignment pin with an outer surface that has a greater wear resistance and/or has a greater tensile strength than the prior art reel finger arrangements.

Finally, it may be beneficial to provide a coating, layer or skin that is sealed against the outer surface of alignment pin 122 (and/or the ring 126) to protect the alignment pin 122 (and/or the ring 126) from the elements and thereby help to prevent corrosion of the alignment pin 122 (and/or the ring 126). Such a coating, layer or skin, depending upon its thickness, could also provide a relatively tight fit between the alignment pin 122 (and/or the ring 126) and the aperture 124 of the bat 116 that would reduce relative movement between the alignment pin 122 and/or the ring 126, and aperture, and thus to reduce chafing.

I claim:

1. A finger (100) configured to be mounted on a bat (116) of a reel of an agricultural harvesting head, the bat (116) defining a mating aperture (124) configured to receive a portion of the finger (100), the finger (100) comprising:
an elongate lower finger portion (102) configured to engage upper portions of crop plants;
an upper clamp portion (104) integrally formed with the elongate lower finger portion (102), wherein the upper clamp portion (104) defines a central region (120) configured to receive the bat (116), the upper clamp portion (104) further comprising,
a strap (106) comprising a polymer that is configured to wrap around the bat (116) and to be attached to the bat (116), and
an alignment pin (122) disposed on an inner surface of the strap (106) and extending into the central region (120) wherein the alignment pin (122) is configured to be received within a mating aperture (124) in the bat (116), and
wherein an outer surface of the alignment pin (122) comprises a material having greater wear resistance or greater tensile strength than the upper clamp portion (104).

2. The finger (100) of claim 1, wherein the alignment pin (122) is solid.

3. The finger (100) of claim 1, wherein the alignment pin (122) comprises a ferrous alloy.

4. The finger (100) of claim 1, wherein the alignment pin (122) comprises a plastic.

5. The finger (100) of claim 4, wherein the alignment pin (122) comprises a reinforced plastic.

6. The finger (100) of claim 1, wherein the alignment pin (122) comprises brass or bronze.

7. The finger (100) of claim 1, wherein the upper clamp portion (104) defines an aperture (134) that is configured to receive and support an end of the alignment pin (122).

8. The finger (100) of claim 1, wherein the elongate lower finger portion (102) and the upper clamp portion (104) are formed as a single injection molded plastic part, and further wherein the alignment pin (122) is pressed into an aperture (134) in the upper clamp portion (104).

9. The finger (100) of claim 1, wherein the elongate lower finger portion (102) and the upper clamp portion (104) are formed as a single injection molded plastic part, in which they are molded around the alignment pin (122).

10. The finger (100) of claim 1, further comprising a threaded fastener (112) that extends through a first aperture (110) in a free end of the strap (106) and is threadedly received in a second aperture (115) formed in a receiver (114) of the upper clamp portion (104).

11. The finger (100) of claim 10, wherein the threaded fastener (112) does not extend into the bat (116).

12. The finger (100) of claim 1, wherein the alignment pin (122) is generally circular in cross-section, and wherein the mating aperture (124) is generally circular in cross-section.

13. The finger (100) of claim 1, wherein a coating, layer, or skin is provided on an outer surface of the alignment pin (122) that is disposed between the alignment pin (122) and the mating aperture (124).

14. A method of molding a finger (100) configured to be mounted on a bat (116) of a reel of an agricultural harvesting head, the bat (116) defining a mating aperture (124) configured to receive a portion of the finger (100), wherein the method of molding a finger (100) comprises steps of:
molding as a unitary body an upper clamp portion (104) configured to fix the finger (100) to the bat (116) and an elongate finger portion (102) configured to engage upper portions of crop plants; and
simultaneously molding an aperture (134) in the upper clamp portion (104) that is configured to support an alignment pin (122), wherein the alignment pin (122) is configured to be received in the mating aperture (124).

15. The method of claim 14, wherein the step of simultaneously molding an aperture (134) further comprises the step of mold-forming the aperture (134) about the alignment pin (122).

16. The method of claim 15, further comprising the step of simultaneously molding a coating, layer, or skin over an outer surface of the alignment pin (122).
